(19) United States
(12) Patent Application Publication
(10) Pub. No.: US 2024/0308620 A1
(43) Pub. Date: Sep. 19, 2024

(54) BICYCLE SUSPENSION ARRANGEMENT

(71) Applicant: POLE BICYCLE COMPANY OY, Muurame (FI)

(72) Inventor: Leo KOKKONEN, Jyväskylä (FI)

(21) Appl. No.: 18/264,982

(22) PCT Filed: Feb. 10, 2022
(86) PCT No.: PCT/EP2022/053244

§ 371 Date: Aug. 10, 2023

(30) Foreign Application Priority Data
Feb. 10, 2021 (FI) 20215136

(51) Int. Cl. B62K 25/28

(52) U.S. Cl. CPC B62K 25/28

(57) ABSTRACT

A suspension arrangement for a vehicle with a frame including rear and front frame parts includes: first and second connection points at the rear and front frame parts, respectively, at least two coupling members connected at first and pivoting second connection points respectively. The second connection points are in the front frame part above the bottom bracket or instant center of the arrangement. A first connection point is above a second connection point, the two connected by a coupling member that is closest to the front of the vehicle frame or higher than another coupling member. Another first connection point connects to a second connection point with a coupling member. A damper connects pivotably to the front and rear frame parts, connecting to a connection point on the rear frame part side of the coupling member closest to the front of the vehicle frame.

### FIELD OF THE INVENTION

Generally, the present invention relates to wheeled vehicle frame structures and suspension arrangements thereof. Particularly, however not exclusively, the present invention pertains to an arrangement for a bicycle suspension arrangement.

### BACKGROUND

Electric motors take up space in the center part of the bicycle frame. The space required by the engine has often been used as an attachment point for the rear frame suspension, especially in 4-bar shortlink suspension solutions. Thus, “Horst”-style 4-bar solutions have become commonplace as the prevailing suspension solution. In racing use, however, the shortlink is an advantage because the suspension profile and anti-squat (AS) characteristics are made more advantageous for efficient advancement. Optimal suspension range and anti-squat are difficult to implement with the Horst model. In Horst suspension, the arc of the rear tire relative to the center of the cranks increases as the suspension progresses, causing excessive chain growth “chain growth”. This chain elongation strains the body and causes the cranks to rotate backwards referred to as “pedal kickback”.

Anti-squat is a mechanical solution that resists the suspension deflection caused by the forces of the transmission. <100% AS means that the suspension tries to compress and >100% AS means the opposite. A 100% AS means that all the force is directed to the driving wheel via the transmission.

A bicycle is different from motored vehicles in that the mass of the bicycle is in usually negligible compared to the mass of the rider. The weight of the bicycle is not enough to create a sag in the suspension if the bicycle springs are adjusted to provide adequate support for the rider. Consequently, when driving on mounds or obstacles such as rocks, roots, et cetera, all the kinetic energy is conveyed directly to the rider and inertia of the bicycle does not help here at all like in heavier vehicle, such as a motorcycle. Motorcycles and cars also utilize spring preload to keep the vehicle's ride height suitable without the need to install strong springs in the vehicle. In a bicycle, prestressing of suspension causes the rider and the wheel to disengage in a low-frequency shock wherein the suspension uses its entire range.

Motored vehicles also use considerably high damping forces compared to bicycles. The damping force can be increased in heavy vehicles without greatly affecting rider comfort due to the higher mass of the vehicle. In a bicycle, increasing the shock absorption force causes discomfort to the rider. In particular, damping of high-frequency vibrations, caused mainly by tree roots and small rocks, is inconvenient because the damping prevents the movement of the suspension. The vibration is thus transmitted to the rider. Low-frequency dampening should be proportionally higher to prevent sharp shocks from applying the suspension too quickly. On the rebound phase of dampening, high-frequency attenuation and low-frequency shocks are also a problem. On the rebound phase of dampening, the problem is caused by large compression, where the suspension rebounds before the rider. In this case, the rider may lose control of the wheel. When the high-frequency rebound attenuation is too high, the suspension is not able to recover and it compresses.

Consequently, the physical limitations of the shock absorber become a problem. With the current state-of-art it is difficult to arrange a shock absorber with low attenuation at high-frequency and progressively relatively more attenuation at low-frequency.

In prior art, efforts have been made to solve the suspension problem with a progressive spring. For example, an air spring is inherently progressive. However, the weakness of an air spring is the stiffness of the initial spring force (breakaway force). The relatively high initial stiffness may be compensated by a negative spring, which in turn causes poor load-bearing capacity in the middle range of deflection. In bicycles, the suspension deflection is usually set according to the weight of the rider at 25-30% of the total range. The aim is to influence the suspension profile by a leverage ratio which, on the spring side, affects the force required to press the spring.

On the shock-absorbing side, the leverage ratio affects the speed of the piston relative to the movement of the rear tire. In addition to mass, the limits of human forces must be considered when designing the suspension. The limit, then, is how hard a person can resist the counterforces caused by their own mass and suspension. In general, the goal is to be able to ride the bicycle as safely as possible. Rider strength and mass are individual boundaries with large differences between individuals. With the load capacity of the spring constant, the dampening properties of a hydraulic shock absorber is aimed to suit all different levels of riders. Hydraulic shock absorption is thus a dynamic part of the suspension. At high stem speeds and frequencies, so-called hysteresis occurs, wherein a kind of empty space is created between the oil and the piston due to the rapid movement of the piston. An “empty point” in the suspension means a point wherein it is not possible to know for sure whether the vehicle is connected to the ground or not. Thus, high hysteresis is disadvantageous in terms of suspension, especially if it occurs in low-frequency attenuations.

### SUMMARY OF THE INVENTION

The objective of the embodiments of the present invention is to at least alleviate one or more of the aforementioned drawbacks evident in the prior art techniques particularly in the context of wheeled vehicle arrangements.

The objective is generally achieved with an arrangement in accordance with the present disclosure.

A technical advantage of the present invention is that it allows for a rear suspension design which leaves space around the bottom bracket of the vehicle frame. Having such space has many advantages and uses but for one this space may be used for easier placement of an electric motor.

Further, with the present invention it is possible to create vehicle frame suspension with optimal anti-squat characteristics and leverage ratio. The present invention allows for a suspension arrangement with progressive suspension profile, leverage ratio and progressively decreasing anti-squat profile.

In accordance with one aspect of the present disclosure suspension arrangement for a vehicle with at least two wheels, the vehicle having a vehicle frame comprising a rear frame part and a front frame part, the suspension arrangement comprising:
at least two first connection points at the rear frame part,
at least two second connection points at the front frame part,
at least two coupling members each connected at a first connection point and a corresponding second connection point, wherein at least second connection points are pivoting connection points,
wherein the at least two second connection points at the front frame part are situated in the front frame part above the bottom bracket of the vehicle frame or above instant center of the suspension,
wherein at least one first connection point is situated above a second connection point to which said first connection point is connected to with a coupling member, said coupling member being closest to the front of the vehicle frame or higher than another coupling member, and
wherein at least another one first connection point is connected to a second connection point with a coupling member,
the suspension arrangement further comprising damper unit operationally connected pivotably in relation to the front frame part and the rear frame part wherein the damper unit is connected to the front frame part and to a connection point, which connection point is on the rear frame part side of the coupling member closest to the front of the vehicle frame.

According to an exemplary embodiment of the present invention the at least another one first connection point is situated above and on the front frame part side of the rear wheel axle.

According to an exemplary embodiment of the present invention the at least another one first connection point is situated above or vertically at the same level with a second connection point to which said first connection point is connected to with a coupling member.

According to an exemplary embodiment of the present invention the suspension arrangement wherein the second connection points are situated above the height of a stretched segment of the drive chain or jackshaft drive of the vehicle.

According to an exemplary embodiment of the present invention the suspension arrangement wherein at least one coupling member is connected pivotably at a first connection point and a corresponding second connection point.

According to an exemplary embodiment of the present invention the suspension arrangement wherein at least one of the second connection points comprises a connecting member, such as an axle, through the front frame part.

According to an exemplary embodiment of the present invention the suspension arrangement wherein the instant center has a curved trajectory wherein the curve stays above the bottom bracket of the vehicle frame.

According to an exemplary embodiment of the present invention the suspension arrangement wherein the instant center has a curved trajectory wherein the curve stays in the front of the bottom bracket of the vehicle frame.

According to an exemplary embodiment of the present invention the suspension arrangement wherein the anti-squat level of the suspension is 90-110%.

In accordance with one aspect of the present disclosure a bicycle comprising the arrangement for a bicycle frame of claim 1.

The present invention is especially usable for mountain, enduro and cross-country bicycle frames that may utilize pivotable coupling between a front frame part and a rear frame part of the vehicle frame. The suspension arrangement may be used in various different vehicles including also motored vehicles, such as electric motor-powered bicycles.

As briefly reviewed hereinbefore, the utility of the different aspects of the present invention arises from a plurality of issues depending on each particular embodiment.

The expression “bicycle” is herein used to refer to various wheeled or wheel-based vehicles for a number of users, which may be manually or motor-powered or a combination of the aforementioned, and it is meant to encompass also tricycles quadracycles, and the like. In a broader sense, the expression may be also seen as to encompass motorbikes.

The expression “a number of” may herein refer to any positive integer starting from one (1). The expression “a plurality of” may refer to any positive integer starting from two (2), respectively.

The term “exemplary” refers herein to an example or example-like feature, not the sole or only preferable option.

Different embodiments of the present invention are also disclosed in the attached dependent claims.

### BRIEF DESCRIPTION OF THE DRAWINGS

Some exemplary embodiments of the present invention are reviewed more closely with reference to the attached drawings, wherein

FIG. 1 illustrates an embodiment of the present invention,

FIG. 2 illustrates an embodiment of the present invention,

FIG. 3 illustrates a leverage ratio profile of an embodiment of the present invention,

FIG. 4 illustrates anti-squat profiles of a number of embodiments of the present invention,

FIG. 5 illustrates anti-squat profiles of a number of embodiments of the present invention, and

FIG. 6 illustrates leverage ratio profiles of a number of embodiments of the present invention.

### DETAILED DESCRIPTION OF THE EMBODIMENTS

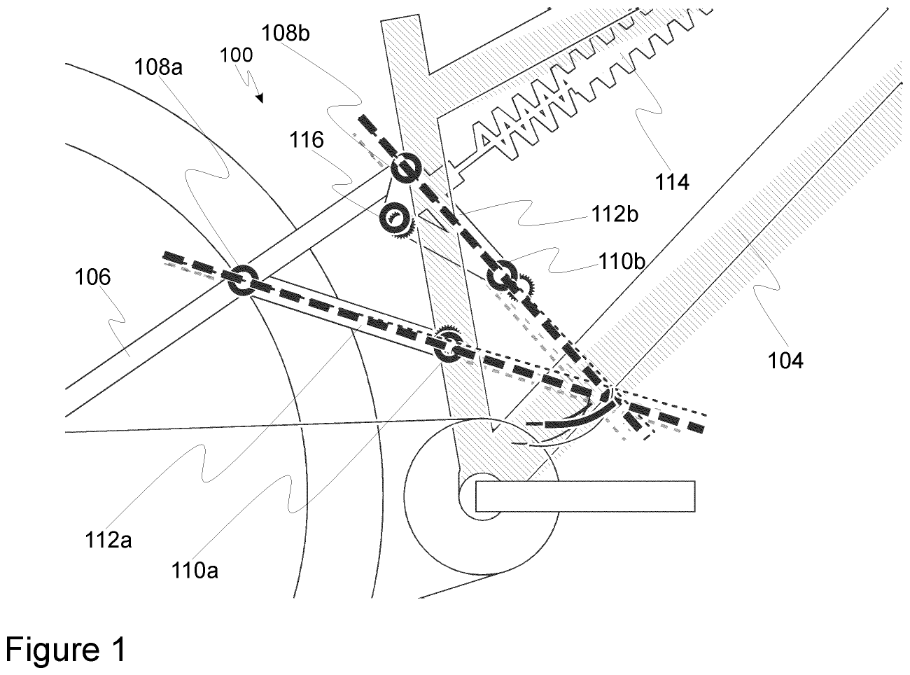

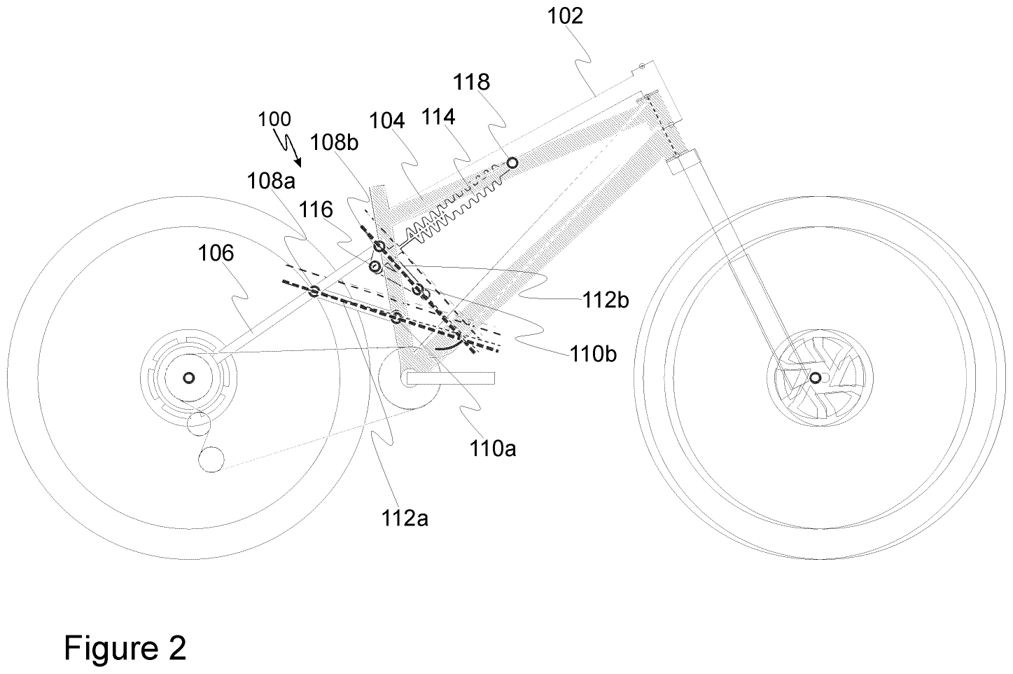

FIGS. 1 and 2 illustrates an embodiment of the arrangement (100). The vehicle in this case is a bicycle having a total vehicle frame (102) comprising a front frame part (104) and a rear frame part (106) connected by the suspension arrangement (100). The line drawing and the patterned drawing of the front frame part (104) illustrate the front frame part (104) and front of the vehicle frame (102) in different positions.

In this embodiment two links on each side of the vehicle frame (102) form a type of 4-bar link suspension arrangement. The suspension arrangement (100) has two first connection points (108a, 108b) at the rear frame part (106) on both sides of the vehicle frame (102) and two second connection points (110a, 110b) at the front frame part (104) on both sides of the vehicle frame (102). In this respect, the first connection points (108a, 108b) and second connection points (110a, 110b) may be seen as points in respect to the vehicle frame (102), which may constitute physical connection points for links or such members between the points but wherein a connection point may constitute a connection point on one point or both sides of the vehicle frame (102) depending on the embodiment. Alternatively, a connection point may be even situated inside either of the frame parts, such as an on axle or such connecting member that may provide for pivoting connection, inside a recess or physically outside either of the frame parts (104, 106) wherein one such example is a horseshoe-shaped recess in the frame whereat a connection may be situated. Also, the rear frame part (106) may comprise space between both sides of the rear frame part (106) sides, formed by the stays therein, in which an axle or such connecting member that may provide for pivoting connection may reside, to which a connection of a link may be made. A number of coupling members (112a, 112b) is connected at a first connection point (108a, 108b) and a corresponding second connection point (110a, 110b) constituting 2, 3 or 4 coupling members in and hence 4, 6 or 8 connection points in total depending on whether the coupling members (112a, 112b) are connected through the front frame part (104) and/or whether the coupling members (112a, 112b) are individual links between a first connection point (108a, 108b) and a second connection point (110a, 110b) on each side of the vehicle frame (102). The two second connection points (110a, 110b) on each side of the vehicle frame (102) are situated in the front frame part (104) above the bottom bracket of the vehicle frame (102). In this embodiment, the two second connection points (110a, 110b) above of the height of a stretched segment of the drive chain upper part as well as above of the height of instant center of the suspension arrangement (100). In some other embodiments, the two second connection points may (110a, 110b) be set on the level of the height of instant center of the suspension arrangement (100). Alternatively, in place of the drive chain a jackshaft drive could be used to drive the rear wheel in which case the two second connection points (110a, 110b) may be above of the height of the jackshaft drive. Alternatively, an idler could be used to drive the rear wheel in which case the two second connection points (110a, 110b) may be above of the height of the idler. However, depending on the embodiment the instant center of the suspension arrangement (100) has a curved profile crossing the height of a stretched segment of the drive chain although none of the instant center profiles cross the bottom bracket of the vehicle. Further, in this embodiment the curved profiles of the instant centers are in the front of the bottom bracket of the vehicle frame (102).

The coupling member (112a, 112b) may comprise an essentially single unit that may go through the front frame part (104) and that connects two second connection points (110a, 110b) and two first connection points (108a, 108b) with links on both sides of the vehicle frame (102). In this embodiment, the links would be connected via a part going through the front frame part (104) and hence a coupling member (112a, 112b) would constitute a link between first connection points (108a, 108b) and second connection points (110a, 110b) wherein the first connection points (108a, 108b) are connection points at both sides of the rear frame part (106) at corresponding or mirroring locations of the rear frame part (106) and the second connection points (110a, 110b) are connection points at both sides of the front frame part (104) at corresponding or mirroring locations of the front frame part (104). The part going through the front frame part (104) may constitute an axle that may rotate in respect to the front frame part (104) or via which a connection point may rotate and hence provide a pivoting point at the second connection points (110a, 110b). Alternatively, the part going through the front frame part (104) may constitute an axle, which is accessible essentially at the center via a recess in the front frame part (104), which axle may rotate in respect to the front frame part (104) or via which a connection point may rotate and hence provide a pivoting point at the second connection points (110a, 110b). Alternatively, corresponding second connection points (110a, 110b) at the front frame part (104) may be located at essentially same locations on each side of the front frame part (104) without having any physical connection therebetween wherein the coupling members (112a, 112b) may comprise links between first connection points (108a, 108b) and second connection points (110a, 110b) separately on each side of the vehicle frame (102).

Since various physical locations for connection points in each frame part are possible the coupling member (112a, 112b) may constitute a number of direct single links between a first and a second connection point, or a “horseshoe-shaped” or such three point-shaped member between one first connection point (108a, 108b) and two second connection points (110a, 110b) or between one second connection point (110a, 110b) and two first connection points (108a, 108b), or a link on a side of the vehicle frame (102) between a second connection point (110a, 110b) and a corresponding first connection point (110a, 110b).

In the illustrated embodiment, both first connection points (108a, 108b) have each a coupling member (112a, 112b) on both sides of the vehicle frame (102), first connection points (108a, 108b) are situated above their corresponding second connection points (110a, 110b) to which said first connection points (108a, 108b) are connected with coupling members (112a, 112b). However, it is necessary that at least the coupling member (112b) closest to the front frame part (104) or closest to the front of the vehicle frame (102) is set in an incline. The coupling member (112b) closest to the front frame part (104) is defined by the coupling member (112b) having its second connection point (110b) closest to the front of the vehicle frame (102). Alternatively, the coupling member (112b) may be defined as the one being higher on the vehicle frame (102) than the other coupling member (112a). The coupling member (112a) closest to the rear of the vehicle frame (102), i.e. having its first connection point (108a) closest to the rear of the vehicle frame, or being lower on the vehicle frame (102) of the two coupling members (112a, 112b) may be set vertically in level or at an incline. In one embodiment the first connection point (108a) is situated above or vertically at the same level with a second connection point (110a) to which said first connection point (108a) is connected to with a coupling member (112a). In another embodiment the first connection point (108a) is situated below or vertically at the same level with a second connection point (110a) to which said first connection point (108a) is connected to with a coupling member (112a). In another embodiment the first connection point (108a) is situated is situated above and on the front frame part (104) side of the rear wheel axle. Further, the placement of damper unit (114) is depicted having a first connection point (118) in the front frame part (104) top tube and a second connection point (116) in a separate member or members connected to the coupling member (112b) or corresponding coupling members (112b) on both sides of the front frame part (104) closest to the front of the vehicle frame (102), or connected to the one or more first connection points (108b) and second connection points (110b), such that the second connection point (116) of the damper unit (114) is behind said coupling member (112b) closest to the front of the vehicle frame (102) or in other words on the rear frame part (106) side of the coupling member (112b) closest to the front of the vehicle frame (102). The damper unit (114) is pivotably connected from both of its connection points.

The two second connection points (110a, 110b) on both sides may comprise means for interlocking the rear frame part (106) in a fixed position relative to said first connection points (108a, 108b). Therein the second connection points (110a, 110b) may comprise means to interlock the rear frame part (106) sides or side parts in a fixed position relative to the second connection points (110a, 110b) for example by having an axle going through the front frame part (104) wherein the axle has links on both ends fixed in relation to each other of the links and which links connect to corresponding points at the rear frame part (106), which allows the rear frame part (106) to be supported by the axle and having at least one pivoting axle in relation to which the rear frame part (106) pivots. Such arrangement essentially interlocks the rear frame part (106) sides relative to the second connection points (110a, 110b) at the second connection points (110a, 110b).

The front and rear frame parts (106) may comprise different shapes as is generally known in the prior art. For example, the rear frame part (106) may comprise an open or closed triangular shaped frame structure with stays or such tube structures connected to at least from one end to a rear wheel. The front frame part (104) may comprise different shapes as is generally known in the prior art. For example, the front frame part (104) may comprise a triangular shaped frame structure with a tube stay and a top tube and a down tube, which tubes connect to a head tube further connected to a front wheel. However, various frame designs are feasible since the suspension arrangement (100) allows for a pivotable connection between the front frame part (104) and the rear frame part (106) with various different configurations and design options of the geometry of the coupling members (112a, 112b) as well as the geometry and characteristics of the damper unit (114) providing freedom for designing the suspension arrangement (100) in view of the preferred vehicle frame (102) characteristics and vice versa.

Suitable coupling member (112a, 112b) materials include for example carbon fibre and other such suitable composites, as well as aluminum, steel and various known alloys. As mentioned, the coupling member (112a, 112b) may comprise a linear or curvilinear link connectable at two ends to two connection points. Another possible embodiment comprises a coupling member (112a, 112b) having two linear links connectable at two ends to two connection points, which links are connectable or physically fixed via an axle or physical part or such structure therebetween essentially constituting at least functionally single coupling member (112a, 112b) that may connect with a first connection point (108a, 108b) on each side of the rear frame part (106). Similarly, another possible embodiment comprises a coupling member (112a, 112b) having a single physical “horseshoe-shaped”, three-point shaped or triangular-shaped structure, which connects two connection points in one frame part to a single connection in another frame part. Further, the coupling member (112a, 112b) itself may be elastic in the sense that it may provide suspension and bend reversibly without breaking.

The damper unit (114) may comprise a shock absorber, such as a hydraulic or pneumatic shock, usable as a rear shock absorber between a front frame part (104) and a rear frame part (106). The damper unit (114) may be chosen or adjusted for rider weight, riding style, terrain, suspension travel, sag, or any combination of these or other factors in view of the preferred suspension design. Essentially the damper unit (114) needs to have a connection point (116) located behind, i.e. on the side closest to the back of the vehicle frame (102), of the line(s) formed by linked and corresponding first connection point (108b) and second connection point (110b) closest to the vehicle frame (102) front whereas another connection point (118) of the damper unit (114) may be somewhere on the front frame part (104) on the side of said line(s) closest to the vehicle frame (102) front. For clarity, the vehicle frame (102) front is the end of the vehicle having a number of front wheels.

By altering the downward coupling member (112a, 112b) orientation and first connection point (108a, 108b) and second connection point (110a, 110b) locations and damper unit (114) connection in limits of the described underlying limitations it is possible to create various types of desired suspension kinematics that may be used for various different applications. Further, with the suspension arrangement (100) of the present disclosure the center of system gravity sets over the vehicle frame (102).

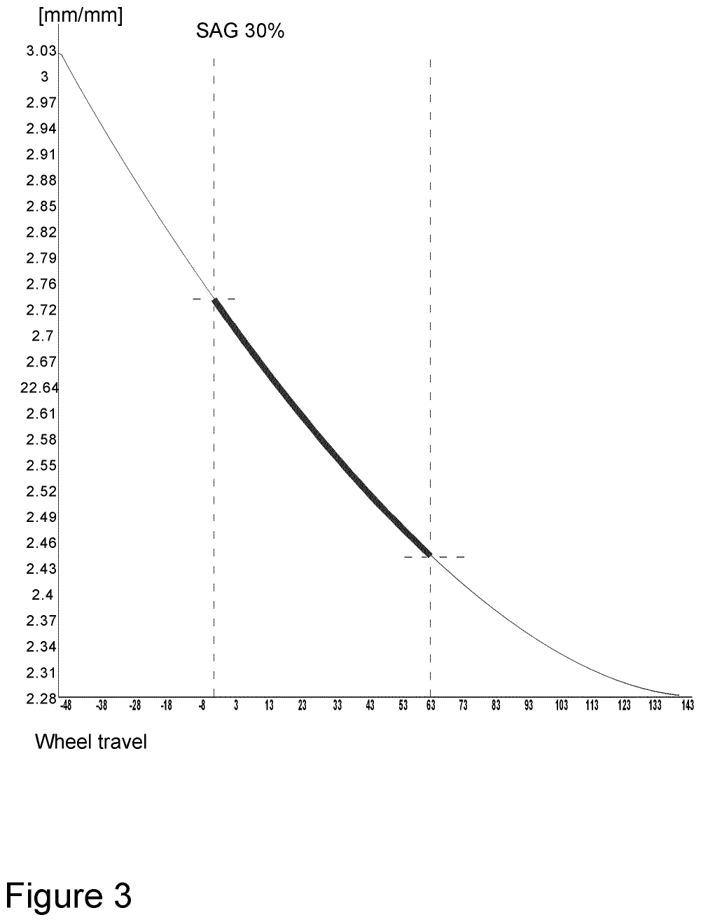

FIGS. 3-6 illustrate various different anti-squat and leverage ratio profiles of various different embodiments of the suspension arrangement (100). Many different anti-squat and leverage ratio settings may be achieved in view of design preferences and the application of the particular suspension arrangement (100) embodiment. However, the suspension arrangement (100) provides for various design options for achieving different anti-squat characteristics and leverage ratio characteristics and profiles thereof, which may be progressive or essentially linear as is presented by the following examples.

FIG. 3 illustrates a leverage ratio profile of a suspension arrangement (100) embodiment. The wheel travel axle is divided into lower non-pedaling zone (below SAG=30%), dynamic SAG zone and upper non-pedaling zone (above dynamic SAG zone). The lower non-pedaling zone has low-frequency and high-frequency impacts with high wheel travel speed. Further, lower non-pedaling zone has decreased damper shaft speed by higher leverage ratio for optimal damping, high leverage ratio for lower breakaway force and higher spring rate. The dynamic SAG zone has optimal damper shaft speed with 2.4:1 to 2.7:1 leverage ratio. The upper non-pedaling zone has low-frequency impacts with low wheel travel speed. The upper non-pedaling zone has also increased shaft speed by lower leverage ratio for more hydraulic damping and low leverage ratio for more spring load support. The leverage ratio profile of this embodiment is shown to have progressive character, which creates better spring support over dynamic SAG zone and allows better damping control in high and low frequency impacts than a linear leverage ratio.

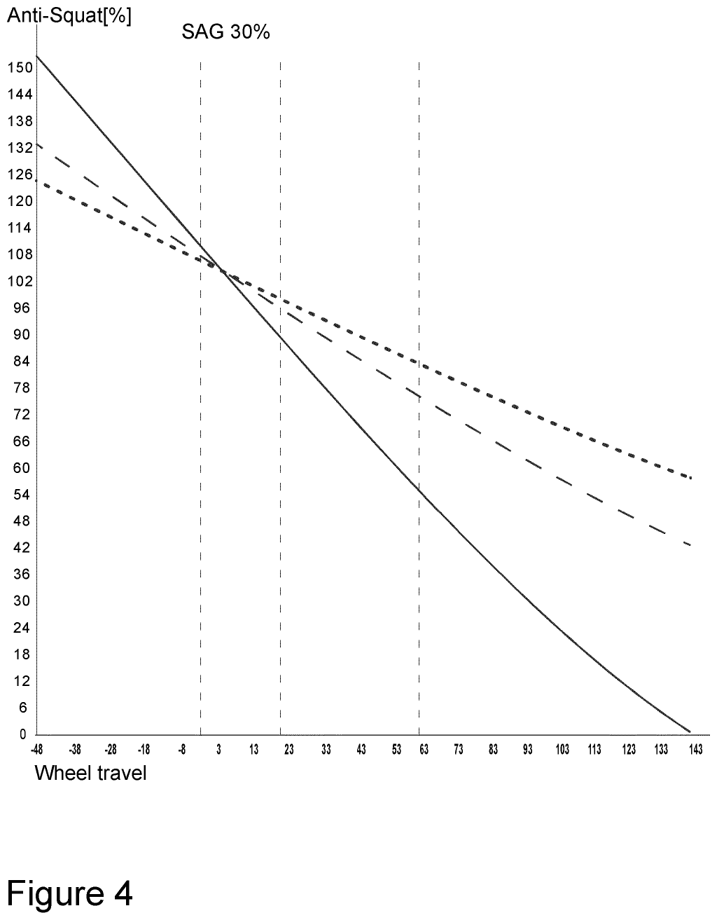

FIG. 4 illustrates three anti-squat profiles of different embodiments of the suspension arrangement (100). In this case, the anti-squat profiles are of different long travel enduro bike embodiments of the suspension arrangement (100). The four zones comprise a lower non-pedaling zone (0-20% SAG), an effective pedaling zone (30-40% SAG), which is the zone wherein pedaling is done sitting down or standing up on an essentially flat surface having high-frequency obstacles, a dynamic pedaling zone (20-60% SAG), which is the zone wherein pedaling is done standing up over obstacles, and an upper non-pedaling zone (above dynamic pedaling zone) wherein due to falling rate of the anti-squat the pedal kickback is low. As is evident from the graph, the suspension ranges of all the profiles are essentially between 90-110% of anti-squat in the effective and dynamic pedaling zones on all gears wherein the start and ending of the anti-squat as well as the shape of the anti-squat curve vary depending on the design, i.e. the configuration of the connection point locations and damper unit (114) connection points and damper unit (114) characteristics. Further, it is possible to achieve progressive anti-squat profiles with the suspension arrangement (100) as is evident from the other examples. Hence, radically different anti-squat profiles may be created with the suspension arrangement (100) of the present disclosure.

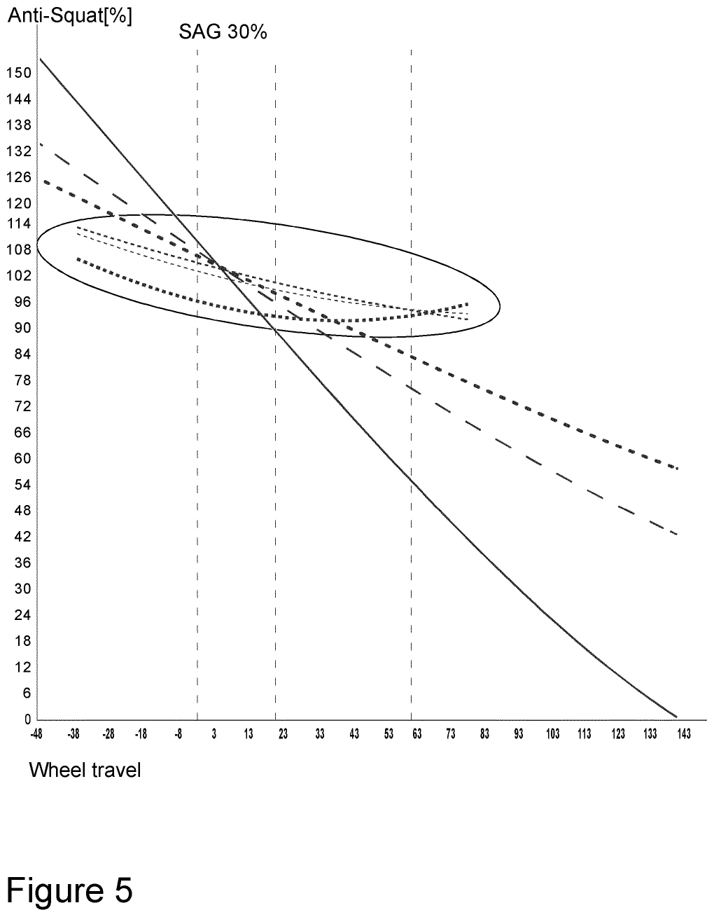

FIG. 5 illustrates six anti-squat profiles of different embodiments of the suspension arrangement (100). In this case, the anti-squat profiles of the long travel enduro bike embodiments of the suspension arrangement (100) are similar to the profiles in FIG. 4. However, the cross-country embodiment anti-squat profiles have optimal anti-squat levels in the range of 90-110% throughout the suspension travel. Herein, some examples of the suspension arrangement (100) embodiments are presented, wherein at SAG 25-55% the average of the anti-squat range of the suspension arrangement (100) is in the range of 80-110% measured at bike and rider combined mass of 80 kg, center of gravity height of 660 mm from bottom bracket with 32 tooth front chainring and 18 tooth rear chainring.

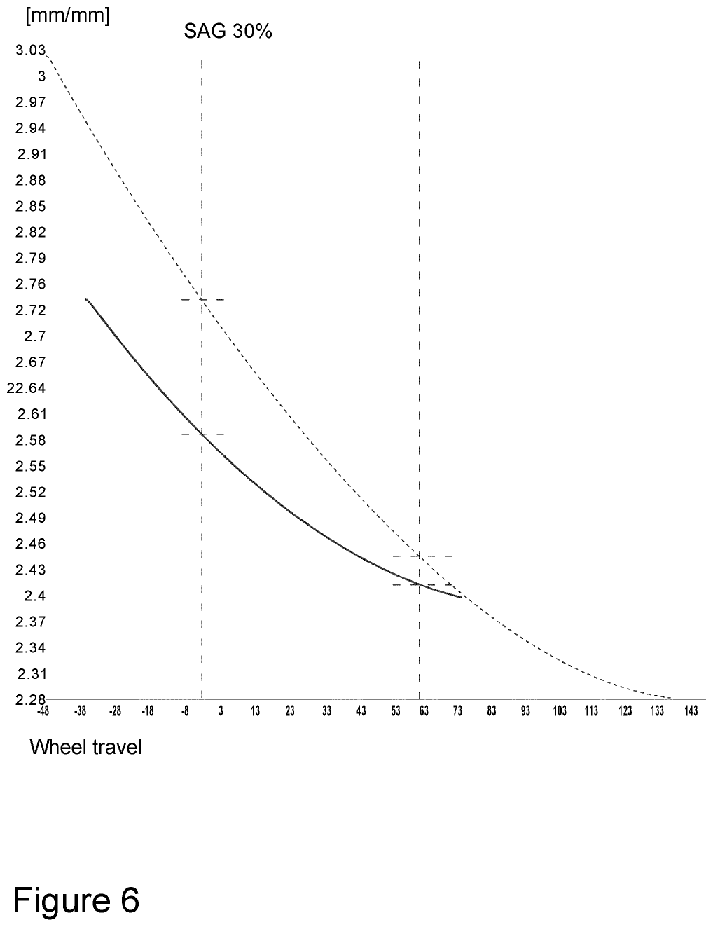

FIG. 6 illustrates two leverage ratio profiles of different embodiments of the suspension arrangement (100). The zones are as described with FIG. 3. Herein, the upper curve is the leverage ratio profile of the suspension arrangement (100) set for an enduro bike embodiment. Herein, the lower curve is the leverage ratio profile of the suspension arrangement (100) set for a cross-country bike embodiment. On the cross-country bike embodiment, the suspension is typically important for traction and comfort of the rider. The lower curve of the leverage ratio profile of the cross-country bike suspension embodiment gives an example wherein at SAG 25-55% an average of the ratio of wheel travel to shock travel of the suspension arrangement (100) is in the range of 2.45-2.65 millimeters measured at bike and rider combined mass of 80 kg, center of gravity height of 660 mm from bottom bracket with 32 tooth front chainring and 18 tooth rear chainring. Therefore, the suspension travel is focused on a zone of leverage ratio that may be seen as an example of zone comfortable for the rider and which leverage ratio is progressive.

The scope of the invention is determined by the attached claims together with the equivalents thereof. The skilled persons will again appreciate the fact that the disclosed embodiments were constructed for illustrative purposes only, and the innovative fulcrum reviewed herein will cover further embodiments, embodiment combinations, variations and equivalents that better suit each particular use case of the invention.

1. A suspension arrangement for a vehicle with at least two wheels, the vehicle having a vehicle frame comprising a rear frame part and a front frame part, the suspension arrangement comprising:
at least two first connection points at the rear frame part,
at least two second connection points at the front frame part,
at least two coupling members each connected at a first connection point and a corresponding second connection point, wherein at least the second connection points are pivoting connection points,
wherein the at least two second connection points at the front frame part are situated in the front frame part above the bottom bracket of the vehicle frame or above instant center of the suspension arrangement-,
wherein at least one first connection point is situated above a second connection point to which said first connection point is connected to with a coupling member, said coupling member being closest to the front of the vehicle frame or higher on the vehicle frame than another coupling member, and
wherein at least another one first connection point is connected to a second connection point with a coupling member,
the suspension arrangement further comprising damper unit operationally connected pivotably in relation to the front frame part- and the rear frame part wherein the damper unit is connected to the front frame part and to a connection point, which connection point is on the rear frame part side of the coupling member closest to the front of the vehicle frame.

2. The suspension arrangement according to claim 1, wherein the at least another one first connection point is situated above and on the front frame part side of the rear wheel axle.

3. The suspension arrangement according to claim 1, wherein the at least another one first connection point is situated above or vertically at the same level with a second connection point- to which said first connection point is connected to with a coupling member.

4. The suspension arrangement according to claim 1, wherein at least one first connection point is situated above or vertically at the same level with a second connection point- to which said first connection point is connected to with a coupling member.

5. The suspension arrangement according to claim 1, wherein the second connection points are situated above the height of a stretched segment of the drive chain, jackshaft drive or idler.

6. The suspension arrangement according to claim 1, wherein at least one of the second connection points comprises a connecting member through the front frame part.

7. The suspension arrangement according to claim 1, the first connection points and the second connection points are located so that the instant center of the suspension arrangement has a curved profile wherein the curve stays above the bottom bracket of the vehicle frame.

8. The suspension arrangement according to claim 1, the first connection points and the second connection points are located so that the instant center has a curved profile wherein the curve stays in the front of the bottom bracket of the vehicle frame.

9. The suspension arrangement according to claim 1, wherein at SAG 25-55% the average of the anti-squat range of the suspension arrangement is in the range of 80%.

10. The suspension arrangement according to claim 1, wherein at SAG 25-55% the average of the ratio of wheel travel to shock travel of the suspension arrangement is in the range of 2.45-2.65 millimeters of rear wheel travel for 1 millimeter shock travel.

11. A bicycle comprising the suspension arrangement of claim 1.

12. The suspension arrangement of claim 6, wherein the connecting member is an axle.

13. The suspension arrangement according to claim 2, wherein at least one first connection point is situated above or vertically at the same level with a second connection point to which said first connection point is connected to with a coupling member.

14. The suspension arrangement according to claim 3, wherein at least one first connection point is situated above or vertically at the same level with a second connection point to which said first connection point is connected to with a coupling member.

15. The suspension arrangement according to claim 2, wherein at least one of the second connection points comprises a connecting member through the front frame part.

16. The suspension arrangement according to claim 3, wherein at least one of the second connection points comprises a connecting member through the front frame part.

17. The suspension arrangement according to claim 4, wherein at least one of the second connection points comprises a connecting member through the front frame part.

18. The suspension arrangement according to claim 5, wherein at least one of the second connection points comprises a connecting member through the front frame part.

19. The suspension arrangement according to claim 2, the first connection points and the second connection points are located so that the instant center of the suspension arrangement has a curved profile wherein the curve stays above the bottom bracket of the vehicle frame.

20. The suspension arrangement according to claim 3, the first connection points and the second connection points are located so that the instant center of the suspension arrangement has a curved profile wherein the curve stays above the bottom bracket of the vehicle frame.
